(19) United States
(12) Patent Application Publication
(10) Pub. No.: US 2026/0204798 A1
(43) Pub. Date: Jul. 16, 2026

(54) Lens With Multiple Compartments Holding Composite Basic Units

(71) Applicant: Matsing, Inc., Irvine, CA (US)

(72) Inventors: Leonid Matytsine, Irvine, CA (US); Serguei Matitsine, Dallas, TX (US)

(21) Appl. No.: 19/182,478

(22) Filed: Apr. 17, 2025

Related U.S. Application Data
(60) Provisional application No. 63/635,525, filed on Apr. 17, 2024.

(51) Int. Cl. H01Q 15/08; H01Q 15/00

(52) U.S. Cl. CPC H01Q 15/08; H01Q 15/006

(57) ABSTRACT

An antenna lens with inter and intra-layer separators having composite basic units disposed in spaces between the separators. Use of multiple composite elements disposed in spaces and arranged in essentially random orientations relative to one another provides a homogeneous overall dielectric constant.

### PRIORITY CLAIM

This application claims priority to US provisional application ser. no. 63/635525, filed Apr. 17, 2024. This and all other referenced extrinsic materials are incorporated herein by reference in their entirety. Where a definition or use of a term in a reference that is incorporated by reference is inconsistent or contrary to the definition of that term provided herein, the definition or use of that term provided herein is deemed to be controlling.

### FIELD OF THE INVENTION

The field of the invention is lens antennas.

### BACKGROUND

The following description includes information that may be useful in understanding the present invention. It is not an admission that any of the information provided herein is prior art or relevant to the presently claimed invention, or that any publication specifically or implicitly referenced is prior art.

RF Lenses can be used for multiple applications (cellular communication, satellite communication, antenna measurement applications). As the demand for transmission of high quality content across cellular networks increases, the need for better large-scale cellular antennae that support higher capacity rises. The commonly used sector antenna designs have several drawbacks.

In some applications, large size lenses of different shapes and different dielectric permittivity may be required (convex lens with single or multiple layers for antenna measurement or satellite application) in which a larger diameter lens can provide a larger aperture and thus greater plane wave zone to measure larger objects. For example, a spherical Luneburg lens with multiple layers (for cellular or satellite applications) in which a larger diameter lens can provide greater gain and greater number of beams

However, construction of such large size lenses is typically limited when using traditional dielectric materials due to their weight, making final lenses extremely heavy and difficult to use (i.e 5 m size convex lenses or Luneburg lenses or bigger). One solution is to use light weight artificial dielectric materials to lower the overall weight of a lens. For example, United States Patent Application Publication No. 2019/0109383 (to Matitsine, et al) describes a method for manufacturing a dielectric material, involving planar layers of an insulating material coated with another layer of conductive and/or magnetic material by application of a foil or film, sputtering, or application of particulates. Another layer of insulating material is then applied to generate a laminar intermediate. In some embodiments the application of conductive and/or magnetic layer(s) and the insulating layer(s) is repeated. The laminar intermediate is divided into multiple basic units which are then imbedded in an insulating matrix, such that the basic units are oriented essentially randomly to each other to produce the material.

While the teachings of Matitsine may provide an isotropic and homogeneous magneto-dielectric effect with its composite material, it still suffers limitations in that the large volume of such dielectric materials necessary to construct large lenses brings about a compacting effect where the materials are crushed under their own weight, settling at the bottom of the lens and thus changing the overall dielectric constant of the lens.

It is possible to reduce the crushing by using hardened materials (particles), however this will add weight and can still cause some crushing effect.

### Problem/Solution

solution for constructing large size, light weight lenses while avoiding crushing and change in dielectric constant of material.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides a method of fabrication of large size, light weight RF Lenses with single or multiple dielectric layers. Lenses are constructed using compartments or a mesh/honeycomb structure in which the dielectric materials can be embedded.

Adjustment of DE: In order to adjust the dielectric constant of the structure to match that of the required dielectric material, structure can have holes/strips to reduce the dielectric constant or have added flakes/glitter/ferro-electric material added to the structure to increase the dielectric constant. Structure can be built having varying layers of dielectric constant to accommodate requirements of type of lens, or a step structure of varying dielectric permittivity to accommodate construction of large size Luneburg lenses. Furthermore, the structure can be constructed or 3D printed in different shapes/compartments depending on requirement or ease of manufacturing.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 shows a compartmentalized structure which is created inside the lens where dielectric material is placed inside the compartments

FIG. 2 shows a combination of two types of spherical/cylindrical compartment structures which are created inside the lens where the dielectric material is placed. One structure larger compartment as well as a smaller compartment placed within a larger compartment (202).

FIG. 3 shows a honeycomb/mesh compartmentalized structure which is created inside the lens where dielectric material is placed inside the compartments

### DETAILED DESCRIPTION

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

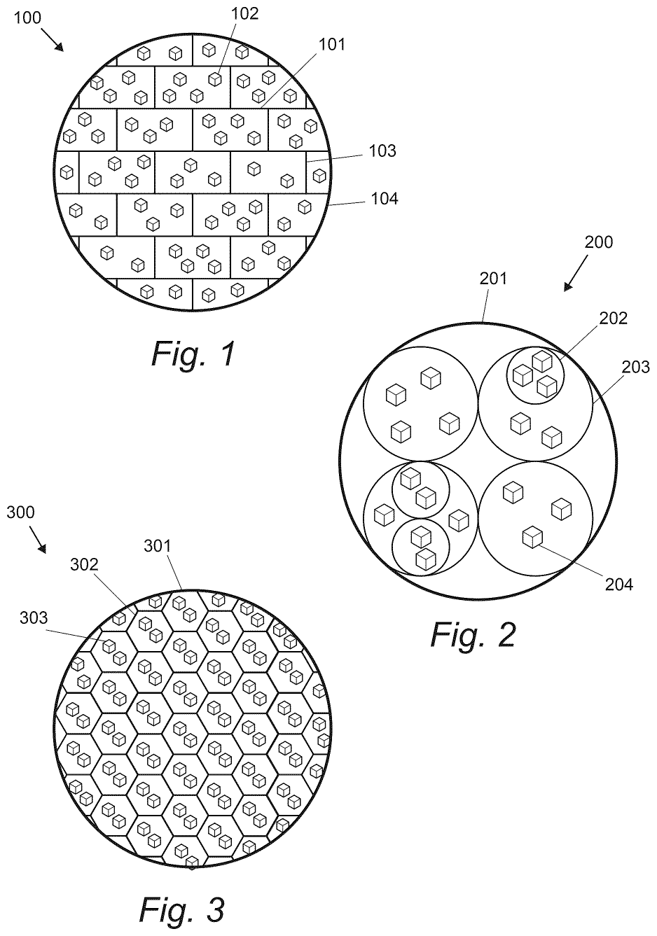

FIG. 1 shows a compartmentalized structure which is created inside the lens where dielectric material is placed inside the compartments and thus reduces the effect of crushing. This structure needs to have the same dielectric constant as the materials being used to fill the structure.

FIG. 2 shows a combination of two types of spherical/cylindrical compartment structures which are created inside the lens where the dielectric material is placed. One structure larger compartment as well as a smaller compartment placed within a larger compartment (202).

FIG. 3 shows a honeycomb/mesh compartmentalized structure which is created inside the lens where dielectric material is placed inside the compartments

Typically standard materials (plastics, rexolite, pvs etc) from which the mesh structure is made from will have a higher dielectric constant then required. To solve this, we propose that the dielectric constant of the structure can be adjusted (or reduced in this instance) by either using thinner (less thick/less material) walls for the compartments or by creating “airspaces” or holes thru out the structure to effectively reduce its dielectric constant. The more holes are used, or the larger the size of the holes, the lower the overall dielectric constant. Different size/shape/orientation and combination of holes can be used. Furthermore, small slits in the mesh/structure can also be used to reduce dielectric constant. Holes can be different shapes (slits, circular, rectangular, triangular etc)

The size of the holes/air spaces needs to be smaller than the size of the particles of dielectric material being used to fill the compartments, otherwise the materials can fall thru the holes or fill the holes thus changing the effective dielectric constant. If the size of the holes is large then the size of the particles, a thin layer needs to be applied (layer thickness has to be several times smaller then size of wavelength of operating frequency of lens in order to create minimal effect on overall dielectric constant). Thin layer can be paper, thin plastic film etc.

Dielectric constant of the mesh/structure can also be increased if required, this can be done by adding metal/ferro-electric strips or particles/discs etc to the walls of the structure. Different size/shape and position of metal/ferro-electric strips can be used or combined. Another possibility is adding such metal/ferro electric particles inside the holes of the structure or simply applying them on top of the structure walls.

If metal strips are used, size of these metal strips or particles need to be several times smaller then size of operating wavelength of the lens.

Ferro-electric particles can be applied to wall of the structure to increase effective dielectric constant.

Another possible solution is to embed air holes within the walls of the structure (which can be done by 3D printing) or by printing the structure from a type of plastic which matches needed dielectric constant. It is important plastic/material used has low RF losses if used for RF applications.

### Method of Construction

When constructing large size lenses, if the mesh structure used has the same dielectric constant as the material being used (has required dielectric constant), the size of each individual compartment is only limited by particle crushing. I. E if each compartment is too large it will cause material to have crushing effect within each compartment.

If the dielectric constant of the mesh is not the same as that of the material being used, it is best to use compartment size and wall thickness which is smaller than 1/2 wavelength (of the operation frequency required) as to reduce diffraction.

The mesh shape/compartment shape can be square (FIG. 1), containers (cylindrical (FIG. 2), spherical (FIG. 2), honeycomb structure (FIG. 3)

Mesh compartments can have thin dielectric layer (paper or cloth) to separate compartments and not allow material to fall thru

Furthermore, for lenses which require multiple dielectric layers, multiple mesh structures in different combinations can be used. For example, a dielectric lens with 2 layers and/or 3 layers or more.

For construction of a large size Luneburg lens, which is made from multiple dielectric onion like layers, a mesh structure with a step structure can be used. In this instance it is important that the height of each mesh compartment (h) is less than the thickness of required Luneburg dielectric layer. At the same time, it is important that the height of each compartment is greater than the size of particles being used. A combination of different structures and heights can be used as needed.

If 3D printing or machined techniques are used, it is possible to create a smooth (non-step) mesh structure to better match spherical onion like layers of Luneburg lens.

Methods described above can be used for different types of lenses (spherical, convex, cylindrical and other shapes) as well as lenses with a single dielectric constant or multiple dielectric constants (such as a Luneburg lens).

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A lens comprising multiple compartments, each of which contains dielectric material.

2. The lens of claim 1, wherein at least one of the compartments contains pieces of the dielectric material.

3. The lens of claim 2, wherein the individual pieces of dielectric material comprise metal flakes.

4. The lens of claim 1, wherein at least one of the compartments has a similar dielectric constant to the dielectric material.

5. The lens of claim 1, wherein at least one of the compartments has holes.
